(19) United States
(12) Patent Application Publication
(10) Pub. No.: US 2020/0157902 A1
(43) Pub. Date: May 21, 2020

(54) Piston Rod

(71) Applicant: Hunting Titan, Inc., Pampa, TX (US)

(72) Inventors: Johnny Covalt, Burleson, TX (US); Rick Blain, Pampa, TX (US); Andy Lane, Lubbock, TX (US); Joseph Albert Henke, Hallettsville, TX (US); Dale Langford, Pampa, TX (US)

(73) Assignee: Hunting Titan, Inc., Pampa, TX (US)

(21) Appl. No.: 16/611,600

(22) PCT Filed: May 18, 2018
(86) PCT No.: PCT/US18/33492

§ 371 Date: Nov. 7, 2019

Related U.S. Application Data
(60) Provisional application No. 62/508,698, filed on May 19, 2017.

(51) Int. Cl. E21B 23/04; E21B 23/06; F16J 1/00

(52) U.S. Cl. CPC E21B 23/04; F16J 1/14; F16J 1/005; E21B 23/06

(57) ABSTRACT

A setting tool that sets a packer or bridge plug in a wellbore using an improved piston rod design.

### RELATED APPLICATIONS

This application claims priority to U.S. Provisional Application No. 62/508,698, filed May 19, 2017.

### BACKGROUND OF THE INVENTION

Generally, when completing a subterranean well for the production of fluids, minerals, or gases from underground reservoirs, several types of tubulars are placed downhole as part of the drilling, exploration, and completions process. These tubulars can include casing, tubing, pipes, liners, and devices conveyed downhole by tubulars of various types. Each well is unique, so combinations of different tubulars may be lowered into a well for a multitude of purposes.

A subsurface or subterranean well transits one or more formations. The formation is a body of rock or strata that contains one or more compositions. The formation is treated as a continuous body. Within the formation hydrocarbon deposits may exist. Typically a wellbore will be drilled from a surface location, placing a hole into a formation of interest. Completion equipment will be put into place, including casing, tubing, and other downhole equipment as needed. Perforating the casing and the formation with a perforating gun is a well known method in the art for accessing hydrocarbon deposits within a formation from a wellbore.

Explosively perforating the formation using a shaped charge is a widely known method for completing an oil well. A shaped charge is a term of art for a device that when detonated generates a focused explosive output. This is achieved in part by the geometry of the explosive in conjunction with an adjacent liner. Generally, a shaped charge includes a metal case that contains an explosive material with a concave shape, which has a thin metal liner on the inner surface. Many materials are used for the liner; some of the more common metals include brass, copper, tungsten, and lead. When the explosive detonates the liner metal is compressed into a super-heated, super pressurized jet that can penetrate metal, concrete, and rock. Perforating charges are typically used in groups. These groups of perforating charges are typically held together in an assembly called a perforating gun. Perforating guns come in many styles, such as strip guns, capsule guns, port plug guns, and expendable hollow carrier guns.

Perforating charges are typically detonated by detonating cord in proximity to a priming hole at the apex of each charge case. Typically, the detonating cord terminates proximate to the ends of the perforating gun. In this arrangement, a detonator at one end of the perforating gun can detonate all of the perforating charges in the gun and continue a ballistic transfer to the opposite end of the gun. In this fashion, numerous perforating guns can be connected end to end with a single detonator detonating all of them.

The detonating cord is typically detonated by a detonator triggered by a firing head. The firing head can be actuated in many ways, including but not limited to electronically, hydraulically, and mechanically.

Expendable hollow carrier perforating guns are typically manufactured from standard sizes of steel pipe with a box end having internal/female threads at each end. Pin ended adapters, or subs, having male/external threads are threaded one or both ends of the gun. These subs can connect perforating guns together, connect perforating guns to other tools such as setting tools and collar locators, and connect firing heads to perforating guns. Subs often house electronic, mechanical, or ballistic components used to activate or otherwise control perforating guns and other components.

Perforating guns typically have a cylindrical gun body and a charge tube, or loading tube that holds the perforating charges. The gun body typically is composed of metal and is cylindrical in shape. Within a typical gun tube is a charge holder designed to hold the shaped charges. Charge holders can be formed as tubes, strips, or chains. The charge holder will contain cutouts called charge holes to house the shaped charges.

Many perforating guns are electrically activated. This requires electrical wiring to at least the firing head for the perforating gun. In many cases, perforating guns are run into the well in strings where guns are activated either singly or in groups, often separate from the activation of other tools in the string, such as setting tools. In these cases, electrical communication must be able to pass through one perforating gun to other tools in the string. Typically, this involves threading at least one wire through the interior of the perforating gun and using the gun body as a ground wire.

Perforating guns and other tools are often connected lowered or conveyed downhole while connected to the surface using a wireline. When pulling the tool back to the surface the tool string may get stuck in the borehole. If too much tension is introduced to the wireline it may fail with a part of the cable falling back into the borehole. Then a fishing tool must be used to grab the loose wireline and pull it back out. This may cause further failures and requires more use of a fishing tool. All of the wireline must be removed before a retrieval tool, such as an overshot style or wash-over style tool, can be used to pull the gun string out itself. This procedure of fishing out the tool may be costly and requires extensive time at the wellsite along with specialized tools.

Releasable tools currently in use may include explosive tools, which use a small booster type explosive to shear a neck, and shear bolts that fail at a predesigned point to allow the wireline to be pulled out of the well intact when a tool string is stuck. Issues with explosive tools may include regulatory issues, transportation issues with the explosive, and the safety concerns of having to pull a live explosive from the wellbore every time the tool string is brought to the surface. Issues with shear bolts is that they may not always fail as designed and an expensive tool may be unnecessarily lost or stuck in the wellbore as a result, or the wireline may still fail because the shear bolts do not function properly.

Bridge plugs are often introduced or carried into a subterranean oil or gas well on a conduit, such as wire line, electric line, continuous coiled tubing, threaded work string, or the like, for engagement at a pre-selected position within the well along another conduit having an inner smooth inner wall, such as casing. The bridge plug is typically expanded and set into position within the casing. The bridge plug effectively seals off one section of casing from another. Several different completions operations may commence after the bridge plug is set, including perforating and fracturing. Sometimes a series of plugs are set in an operation called “plug and perf” where several sections of casing are perforated sequentially. When the bridge plug is no longer needed the bridge plug is reamed, often though drilling, reestablishing fluid communication with the previously sealed off portion of casing.

Setting a bridge plug typically requires setting a “slip” mechanism that engages and locks the bridge plug with the casing, and energizing the packing element in the case of a bridge plug. This requires large forces, often in excess of 20,000 lbs. The activation or manipulation of some setting tools involves the activation of an energetic material such as an explosive pyrotechnic or black powder charge to provide the energy needed to deform a bridge plug. The energetic material may use a relatively slow burning chemical reaction to generate high pressure gases. One such setting tool is the Model E-4 Wireline Pressure Setting Tool of Baker International Corporation, sometimes referred to as the Baker Setting Tool.

The pressure from the power charge igniting is contained with the power charge chamber by the sealed firing head. The pressure builds in the chamber and causes a floating first piston to move down through the tool, compressing the oil reservoir through a small hole in a connector sub.

The oil is pressed through the small hole in the connector sub and against a second piston. The hydraulic force applied against the second piston causes the piston to move. The second piston is coupled to a setting sleeve by way of a piston rod and sleeve crosslink. The setting sleeve moves away axially from the setting tool and compresses the outside of a bridge plug. A mandrel located down the center of the tool stays stationary. The mandrel is connected to the bridge plug via a shear stud. After the bridge plug is set, the setting tool is pulled upwards in the borehole until sufficient force is generated to shear the shear stud, thus separating the setting tool from the bridge plug.

After the bridge plug is set, the explosive setting tool remains pressurized and must be raised to the surface and depressurized. This typically entails bleeding pressure off the setting tool by piercing a rupture disk or releasing a valve.

### SUMMARY OF EXAMPLE EMBODIMENTS

An example embodiment may include a piston assembly for a setting tool having a substantially cylindrical piston head that is rotationally symmetrical about an axis and having an inner bore extending from a lower face of the piston head partially into the piston head toward an upper face of the piston head along the axis, a piston rod having a threaded portion threadably engaged in the inner bore and an elongated portion extending away from the piston head.

A variation of the example embodiment may include a threaded portion and a thread relief portion of the inner bore having no threads between the threaded portion of the inner bore and the lower face. The threaded portion of the inner bore may have a maximum diameter corresponding to the relief portion of the threads and the thread relief portion of the inner bore has a diameter larger than the maximum diameter of the threaded portion of the inner bore. It may include a set screw bore and corresponding set screw in the piston head extending radially from the thread relief portion of the inner bore. It may include a set screw bore and corresponding set screw in the piston head extending radially from the inner bore. It may include a first o-ring groove 16 about a circumference of the piston head. It may include a plurality of o-ring grooves 16 about a circumference of the piston head. The piston rod may include a slot distal from the threaded portion adapted to engage a crosslink.

An example embodiment may include a setting tool having a lower cylinder 30, a substantially cylindrical piston head within lower cylinder that is rotationally symmetrical about an axis and having a threaded inner bore extending from a lower face of the piston head partially into the piston head toward an upper face of the piston head along the axis, a piston rod having a threaded portion threadably engaged in the inner bore and an elongated portion extending away from the piston head, a mandrel extending from the lower cylinder away from the piston head, a crosslink sleeve slideably engaged around the mandrel, a crosslink coupling the elongated portion of the piston rod to the crosslink sleeve, in which movement of the piston head causes relative movement between the mandrel and the crosslink sleeve.

A variation of the example embodiment may include a threaded portion and a thread relief portion of the inner bore having no threads between the threaded portion of the inner bore and the lower face. The threaded portion of the inner bore may have a maximum diameter corresponding to the relief portion of the threads and the thread relief portion of the inner bore has a diameter larger than the maximum diameter of the threaded portion of the inner bore. It may include a set screw bore and corresponding set screw in the piston head extending radially from the thread relief portion of the inner bore. It may include a set screw bore and corresponding set screw in the piston head extending radially from the inner bore. It may include a first o-ring groove about a circumference of the piston head. The piston rod may include a slot distal from the threaded portion adapted to engage a crosslink.

### BRIEF DESCRIPTION OF THE DRAWINGS

For a thorough understanding of the present invention, reference is made to the following detailed description of the preferred embodiments, taken in conjunction with the accompanying drawings in which reference numbers designate like or similar elements throughout the several figures of the drawing. Briefly:

FIG. 1 depicts a cross-sectional side view of a piston rod.

FIG. 2A depicts a cross-sectional side view of a setting tool.

FIG. 2B depicts a close-up of a cross-section side view of a lower piston on a setting tool.

FIG. 3A depicts a cross-sectional side view of a tool string after setting.

FIG. 3B depicts a close-up of a cross-section side view of a lower piston on a setting tool.

### DETAILED DESCRIPTION OF EXAMPLES OF THE INVENTION

In the following description, certain terms have been used for brevity, clarity, and examples. No unnecessary limitations are to be implied therefrom and such terms are used for descriptive purposes only and are intended to be broadly construed. The different apparatus, systems and method steps described herein may be used alone or in combination with other apparatus, systems and method steps. It is to be expected that various equivalents, alternatives, and modifications are possible within the scope of the appended claims.

An example embodiment may include a cablehead assembly which has a wireline coupled to the uphole end of a fish neck assembly. A casing collar locator, sometimes abbreviated CCL, is located downhole from and coupled to the downhole end of the fish neck assembly. A quick change assembly is located downhole from and coupled to the downhole end of the casing collar locator assembly. A firing head assembly is located downhole from and coupled to the downhole end of the quick change assembly. A setting tool assembly is located downhole from and coupled to the downhole end of the firing head assembly. The downhole end of the setting tool assembly is coupled to a setting sleeve and a tension mandrel. The tension mandrel is coupled to a bridge plug using a shear stud.

In operation the operator sends a signal through the wireline, which causes the firing head assembly to ignite a chemical power charge. The expanding gas generated from the power charge causes the setting tool assembly to mechanically extend in such a way that the setting sleeve moves downhole relative to a tension mandrel, which stays stationary. The setting sleeve mechanically collapses a bridge plug, or other expandable completions tool, which causes it to expand and seal off the casing at a desired location in which the tool string is located. After the bridge plug is expanded, sufficient stress builds up in a shear stud to cause it to separate from the bridge plug. Once separated, the rest of the tool string can be moved uphole while the bridge plug stays in place in the casing. In addition to a bridge plug, the setting tool can be used to expand or plug a variety of downhole completions equipment at desired locations within the borehole.

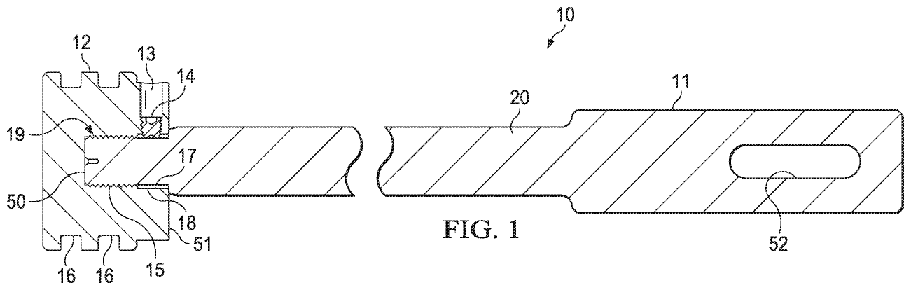

Referring to FIG. 1, a setting tool uses a piston assembly 10 to convert a working fluid, such as gas or fluid, pressure into a mechanical longitudinal motion for setting a packer. The working fluid acts on the piston head 12. The piston head 12 has an inner bore 17 with threads 15 and a thread relief 18. Inner bore 17 is located partially in the piston head 12, starting from inner face 50 and extending to the upper face 51. O-ring grooves 16 allow for one or more o-rings to seal the piston head 12 within a cylinder. A piston rod 11 has a threaded portion 19 that screws into the threads 15 of the piston head 12. Piston rod 11 has a slot 52 adapted for engaging with a crosslink. This threaded couple allows for the piston to be rigidly engaged and held to a closer concentric tolerance than previous designs. The force acting on the piston head 12 is transferred to the distal end. The threaded portion 19 and the threads 15 prevent the piston rod from moving axially off center. The threaded couple reduces bending forces in the piston rod 11, thereby preventing failures and deformation of the piston rod 11. Bending of the elongated portion 20 of the piston rod 11 may cause failure which may result in an incomplete setting job. Another problem of piston rod bending is that it can cause the piston assembly 10 to get stuck in the cylinder. Piston rod bending or failure could also damage the rest of the setting tool, thus negatively impacting the reusability of the setting tool.

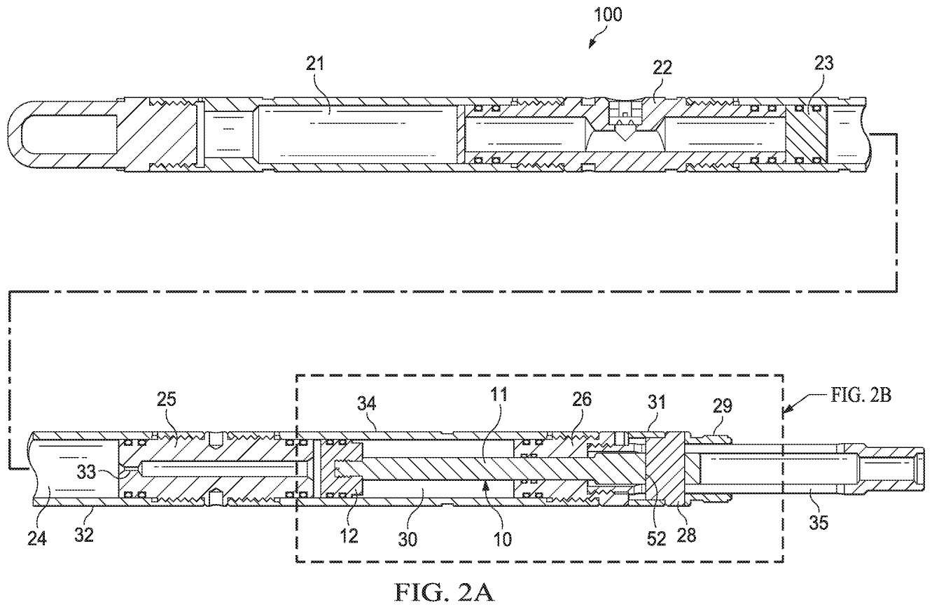

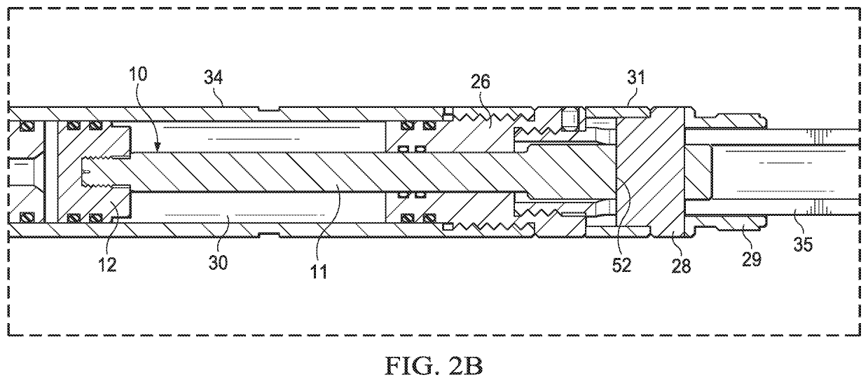

Referring to FIG. 2A, a cross-section of the setting tool assembly 100 is shown in a pre-setting configuration, prior to coupling with additional tool string components and prior to placement downhole. A power charge chamber 21 is located uphole from and coupled to the ported bleeder sub 22. The ported bleeder sub 22 is located uphole from and coupled to the upper cylinder housing 32. The inner bore of upper cylinder housing 32 forms upper cylinder 24. The upper piston 23 is slideably engaged with the upper cylinder 24. The upper cylinder housing 32 is uphole from and coupled to the tandem connector 25. Generally the upper cylinder 24 will contain a working fluid, such as a hydraulic fluid, between the upper piston 23 and the tandem connector 25. The tandem connector 25 contains a metering fluid passageway 33 for regulating the flow of the working fluid through the tandem connector 25. The tandem connector 25 is located uphole from and coupled to the lower cylinder housing 34. The inner bore of the lower cylinder housing 34 forms a lower cylinder 30.

Still referring to FIG. 2A, a piston rod assembly 10 is slideably disposed within the lower cylinder 30. The piston rod assembly 10 includes a piston head 12 and a piston rod 11. The piston rod head 12 is slideably engaged with the lower cylinder 30. The piston rod 11 is slideably engaged with the cylinder head 26. The piston rod 11 is engaged with and coupled to the crosslink 28 via slot 52 and held in place using crosslink retaining ring 31. The crosslink 28 is engaged with and coupled to the crosslink sleeve 29. The crosslink sleeve 29 is slideably engaged over mandrel 35. Mandrel 35 is static as the cross link sleeve 29 slides longitudinally downhole when the setting tool assembly 100 is engaged. This allows the setting tool assembly 100 to push downward on the exterior of a packer while holding the interior of the packer, forcing the packer to expand radially and engage against the borehole.

Referring to FIG. 2B, a close up of the piston rod assembly 10 located within the setting tool assembly 100, a piston rod assembly 10 is slideably disposed within the lower cylinder 30. The piston rod assembly 10 includes a piston head 12 and a piston rod 11. The piston rod head 12 is slideably engaged with the lower cylinder 30. The piston rod 11 is slideably engaged with the cylinder head 26. The piston rod 11 is engaged with and coupled to the crosslink 28 via slot 52 and held in place using crosslink retaining ring 31. The crosslink 28 is engaged with and coupled to the crosslink sleeve 29. The crosslink sleeve 29 is slideably engaged over mandrel 35.

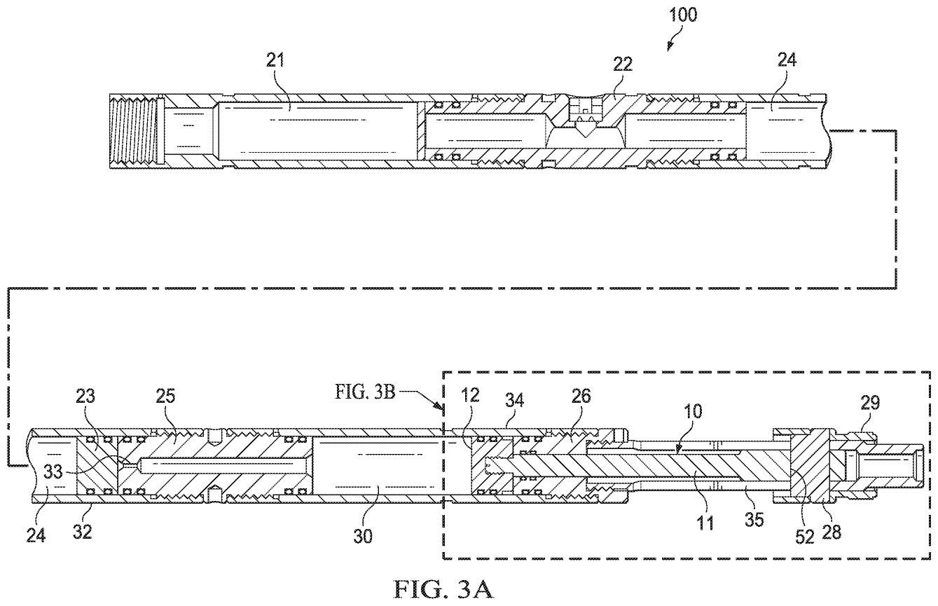

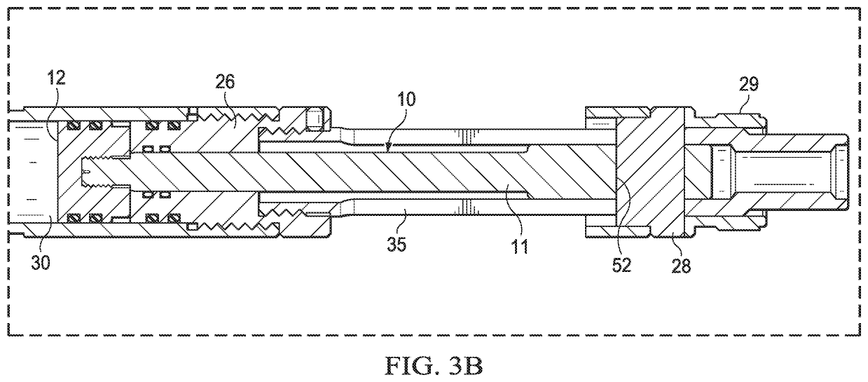

Referring to FIG. 3A, a cross-section of the setting tool assembly 100 is shown in a post-setting configuration. A power charge chamber 21 is located uphole from and coupled to the ported bleeder sub 22. The ported bleeder sub 22 is located uphole from and coupled to the upper cylinder housing 32. The inner bore of upper cylinder housing 32 forms upper cylinder 24. The upper piston 23 is slideably engaged with the upper cylinder 24. The upper cylinder housing 32 is uphole from and coupled to the tandem connector 25. Generally the upper cylinder 24 will contain a working fluid, such as a hydraulic fluid, between the upper piston 23 and the tandem connector 25. The tandem connector 25 contains a metering fluid passageway 33 for regulating the flow of the working fluid through the tandem connector 25. The tandem connector 25 is located uphole from and coupled to the lower cylinder housing 34. The inner bore of the lower cylinder housing 34 forms a lower cylinder 30.

Still referring to FIG. 3A, a piston rod assembly 10 is slideably disposed within the lower cylinder 30. The piston rod assembly 10 includes a piston head 12 and a piston rod 11. The piston rod head 12 is slideably engaged with the lower cylinder 30. The piston rod 11 is slideably engaged with the cylinder head 26. The piston rod 11 is engaged with and coupled to the crosslink 28 via slot 52 and held in place using crosslink retaining ring 31. The crosslink 28 is engaged with and coupled to the crosslink sleeve 29. The crosslink sleeve 29 is slideably engaged over mandrel 35. Mandrel 35 is static as the cross link sleeve 29 slides longitudinally downhole when the setting tool assembly 100 is engaged. In this post-setting configuration the working fluid has pushed the piston assembly 10 downhole until it bottoms out against the cylinder head 26. This results in the crosslink sleeve 29 moving downhole, with the mandrel 35, slideably disposed within the crosslink sleeve 29, remaining stationary. The end result is a combination of pushing and holding that allows for the setting of a bridge plug, packer, or other expandable completion tool.

Referring to FIG. 3B, a close up of the piston rod assembly 10 located within the setting tool assembly 100 after the setting tool assembly 100 has been engaged. A piston rod assembly 10 is slideably disposed within the lower cylinder 30. The piston rod assembly 10 includes a piston head 12 and a piston rod 11. The piston rod head 12 is slideably engaged with the lower cylinder 30. The piston rod 11 is slideably engaged with the cylinder head 26. The piston rod 11 is engaged with and coupled to the crosslink 28 via slot 52 and held in place using crosslink retaining ring 31. The crosslink 28 is engaged with and coupled to the crosslink sleeve 29. The crosslink sleeve 29 is slideably engaged over mandrel 35.

Operating the described embodiment includes assembling the tool string, lowering it into a wellbore, using, for example, the casing collar locator assembly to accurately determine the position of the tool string, positioning a bridge plug, packer, or other expandable at a desired location within the wellbore, igniting the power charge via a signal from the wireline to the firing head assembly, extending the setting tool assembly 100 using the gases from the power charge, setting the bridge plug with the crosslink sleeve 29 moving downhole while the mandrel 35 remains stationary, then pulling the tool string uphole.

A bridge plug is used in the examples disclosed herein, however several other tools could be used in this application, such as packers, which may be deployed using a setting tool assembly as disclosed herein.

Although the invention has been described in terms of embodiments which are set forth in detail, it should be understood that this is by illustration only and that the invention is not necessarily limited thereto. For example, terms such as upper and lower or top and bottom can be substituted with uphole and downhole, respectfully. Top and bottom could be left and right, respectively. Uphole and downhole could be shown in figures as left and right, respectively, or top and bottom, respectively. Generally downhole tools initially enter the borehole in a vertical orientation, but since some boreholes end up horizontal, the orientation of the tool may change. In that case downhole, lower, or bottom is generally a component in the tool string that enters the borehole before a component referred to as uphole, upper, or top, relatively speaking. The first housing and second housing may be top housing and bottom housing, respectfully. Terms like wellbore, borehole, well, bore, oil well, and other alternatives may be used synonymously. Terms like tool string, tool, perforating gun string, gun string, or downhole tools, and other alternatives may be used synonymously. The alternative embodiments and operating techniques will become apparent to those of ordinary skill in the art in view of the present disclosure. Accordingly, modifications of the invention are contemplated which may be made without departing from the spirit of the claimed invention.

What is claimed is:

1. A piston assembly for a setting tool comprising:
a substantially cylindrical piston head 12 that is rotationally symmetrical about an axis and having an inner bore 17 extending from a lower face 50 of the piston head 12 partially into the piston head 12 toward an upper face 51 of the piston head 12 along the axis; and
a piston rod having a threaded portion 19 threadably engaged in the inner bore and an elongated portion extending away from the piston head.

2. The piston assembly of claim 1 further comprising a threaded portion and a thread relief portion 18 of the inner bore having no threads between the threaded portion of the inner bore and the lower face.

3. The piston assembly of claim 2 wherein the threaded portion of the inner bore has a maximum diameter corresponding to the relief portion of the threads and the thread relief portion of the inner bore has a diameter larger than the maximum diameter of the threaded portion of the inner bore.

4. The piston assembly of claim 3 further comprising a set screw bore and corresponding set screw in the piston head extending radially from the thread relief portion of the inner bore.

5. The piston assembly of claim 1 further comprising a set screw bore and corresponding set screw in the piston head extending radially from the inner bore.

6. The piston assembly of claim 1 further comprising a first o-ring groove 16 about a circumference of the piston head.

7. The piston assembly of claim 1 further comprising a plurality of o-ring grooves 16 about a circumference of the piston head.

8. The piston assembly of claim 1 wherein the piston rod further comprises a slot 52 distal from the threaded portion 19 adapted to engage a crosslink 28.

9. A setting tool comprising:
a lower cylinder 30;
a substantially cylindrical piston head 12 within lower cylinder 30 that is rotationally symmetrical about an axis and having a threaded inner bore extending from a lower face 50 of the piston head partially into the piston head toward an upper face 51 of the piston head along the axis;
a piston rod having a threaded portion 19 threadably engaged in the inner bore and an elongated portion extending away from the piston head;
a mandrel extending from the lower cylinder away from the piston head;
a crosslink sleeve 29 slideably engaged around the mandrel;
a crosslink 28 coupling the elongated portion of the piston rod to the crosslink sleeve; and
wherein movement of the piston head causes relative movement between the mandrel 35 and the crosslink sleeve 29.

10. The setting tool of claim 9 further comprising a threaded portion and a thread relief portion of the inner bore having no threads between the threaded portion of the inner bore and the lower face.

11. The setting tool of claim 10 wherein the threaded portion of the inner bore has a maximum diameter corresponding to the relief portion of the threads and the thread relief portion of the inner bore has a diameter larger than the maximum diameter of the threaded portion of the inner bore.

12. The setting tool of claim 11 further comprising a set screw bore and corresponding set screw in the piston head extending radially from the thread relief portion of the inner bore.

13. The setting tool of claim 9 further comprising a set screw bore and corresponding set screw in the piston head extending radially from the inner bore.

14. The setting tool of claim 9 further comprising a first o-ring groove about a circumference of the piston head.

15. The setting tool of claim 9 wherein the piston rod further comprises a slot 52 distal from the threaded portion 19 adapted to engage a crosslink 28.
